(19) United States
(12) Patent Application Publication
(10) Pub. No.: US 2019/0385045 A1
(43) Pub. Date: Dec. 19, 2019

(54) Systems And Methods For Generalized Adaptive Storage Endpoint Prediction

(71) Applicant: DELL PRODUCTS L.P., Round Rock, TX (US)

(72) Inventors: Deepesh Cherlam Poovalapil, Bangalore (IN); Niladri Bhattacharya, West Bengal (IN); Sourabh Gavhale, Pune (IN)

(21) Appl. No.: 16/008,832

(22) Filed: Jun. 14, 2018

(51) Int. Cl. G06N 3/04; G06K 9/62; G06F 3/06; G06N 5/04

(52) U.S. Cl. CPC G06N 3/0472; G06K 9/6226; G06F 3/0679; G06N 5/046; G06F 3/0629; G06F 3/0604

(57) ABSTRACT

Systems and methods are provided that that may be implemented to perform generalized adaptive storage endpoint prediction. A system/storage management application gathers data samples pertaining to operation of a storage device (e.g., remaining rated write endurance, available spare blocks, remaining drive space), clusters the data samples (e.g., using DBSCAN algorithm), and approximates a polynomial function usable to predict an endpoint of the storage device (e.g., SSD) by using an artificial neural network that receives the data samples and clusters and in response generates the approximated polynomial function. The approximate polynomial function may be a combination of Gaussian functions corresponding to the clusters. A mean and variance associated with each cluster may be calculated that is a mean and variance of a corresponding Gaussian function. A feed forward artificial neural network having at least one hidden layer, constant bias, and Gaussian activation function may be employed.

### FIELD

This invention relates generally to information handling systems and, more particularly, to system and/or storage management.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Current storage management solutions provide only monitoring capability for data usage, storage capacity, and lifetime of Solid State Drives (SSD) to users, e.g., system managers. The solutions are lacking in a methodology to employ storage usage data to predict a need for expansion of storage capacity prior to its depletion. The solutions are lacking in information about the complete lifecycle of the SSDs based on the drive usage. A user is required to continuously monitor the end of life of the storage device for avoiding data loss.

### SUMMARY

Disclosed herein are systems and methods that may be implemented to provide a generalized adaptive solution by analyzing live storage data (e.g., remaining rated write endurance (RRWE), remaining drive space, etc.) and the time line of storage. The time line prediction may provide a user with information usable to maintain storage hardware and avoid data loss due to unavailability of storage devices. The system and methods include intelligence in system/storage management by analyzing unstructured live data. The system and methods may predict any non-linear function from low dimensional low sample size data and can be used for similar scenarios.

In one respect, disclosed herein is an information handling system, including a programmable integrated circuit, a storage device, and a system/storage management application executing on the programmable integrated circuit. The system/storage management application gathers data samples pertaining to operation of the storage device, clusters the data samples into a plurality of clusters, and approximates a polynomial function usable to predict an endpoint of the storage device by using an artificial neural network that receives the data samples and clusters and in response generates the approximated polynomial function.

In another respect, disclosed herein is a method for use in an information handling system having a storage device, the method including gathering data samples pertaining to operation of the storage device, clustering the data samples into a plurality of clusters, and approximating a polynomial function usable to predict an endpoint of the storage device by using an artificial neural network that receives the data samples and clusters and in response generates the approximated polynomial function.

In another respect, disclosed herein is a non-transitory computer-readable medium having instructions stored thereon that are capable of causing or configuring an information handling system having at least one programmable integrated circuit and a storage device to perform operations comprising: gathering data samples pertaining to operation of the storage device; clustering the data samples into a plurality of clusters; and approximating a polynomial function usable to predict an endpoint of the storage device by using an artificial neural network that receives the data samples and clusters and in response generates the approximated polynomial function.

### BRIEF DESCRIPTION OF THE DRAWINGS

FIG. 1 is a block diagram of an information handling system as it may be configured according to one exemplary embodiment to perform generalized adaptive storage endpoint prediction.

FIG. 2 is a flow diagram illustrating operation of the information handling system to perform generalized adaptive storage endpoint prediction according to one embodiment of the disclosed systems and methods.

FIG. 3 is a block diagram illustrating a neural network that may be executed by the information handling system of FIG. 1 according to one embodiment of the disclosed systems and methods.

FIG. 4 is a graph illustrating aspects of operation of the information handling system of FIG. 1 according to one embodiment of the disclosed systems and methods

FIG. 5 is a graph illustrating aspects of the operation of the information handling system of FIG. 1 according to one embodiment of the disclosed systems and methods.

FIGS. 6, 7 and 8 are flow diagrams illustrating operation of the information handling system for first, second and third respective use cases according to embodiments of the disclosed systems and methods.

### DESCRIPTION OF ILLUSTRATIVE EMBODIMENTS

Disclosed are embodiments of systems and methods that provide a generalized way of predicting a storage-related function with low dimensional low sample space (LDLSS) data, such as remaining rated write endurance (RRWE), available spare percentage, remaining drive space of an SSD, and/or remaining storage capacity of all SSDs in an information handling system. The information content in the LDLSS data may be significantly less. The disclosed embodiments address the problem by using data pre-processing, adaptive clustering and neural network techniques. The embodiments initially preprocess LDLSS data to enhance patterns in the data so that it can be used for predicting with a greater accuracy. Next, similar data is clustered, or grouped. In one embodiment, DBSCAN (density based spatial clustering of application with noise) is employed to cluster/group the data having a similar pattern and to return cluster labels for all data points. The data points with the cluster labels are then passed through a neural network (e.g., a single layer feed-forward artificial neural network) to generate a polynomial function of varied order that best fits the data samples.

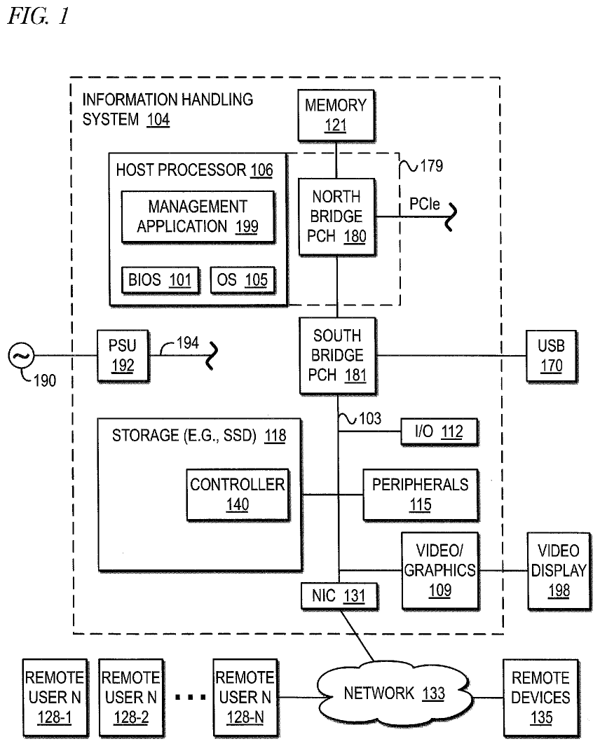

FIG. 1 is a block diagram of an information handling system 104 (e.g., such as a server, desktop computer, laptop, etc.) as it may be configured according to one exemplary embodiment to perform generalized adaptive storage endpoint prediction. As shown, system 104 may include one or more host processing device/s 106 (e.g., AMD or Intel-based CPU such as Itanium or any other type of suitable host processing device), one or more buses or communication media 103 (e.g., PCIe bus, USB, SMBus, SATA, other appropriate data buses such as memory bus, etc.), video/graphics hardware 109 (e.g., video adapter or graphics processor unit), storage 118 (e.g., solid state drive (SSD), hard disk drive and/or optical drive, etc.), system volatile memory 121 (e.g., DRAM), local input/output (I/O) 112, peripherals 115 (e.g., keyboard, mouse, etc.), and remote access controller (RAC) (not shown). Examples of a remote access controller include an integrated Dell Remote Access Controller (iDRAC) available from Dell Products L.P. of Round Rock, Tex., etc.). In the exemplary embodiment of FIG. 1, host processing device/s 106 is configured to load and run a Basic Input Output System (BIOS) 101 (e.g., UEFI firmware), host OS 105 (e.g., Windows-based OS, Linux-based OS, etc.), and a system/storage management application 199, among others. The video/graphics hardware 109 controls a video display 198. The storage device 118 includes a controller 140. The storage device 118 is an example of a storage device about which generalized adaptive endpoint prediction may be performed. The controller 140 may provide data samples to the system/storage management application 199 about the storage device 118 which the system/storage management application 199 processes to generate a function that may be used to predict an endpoint of the storage device 118. In one embodiment, the management application 199 is a version of the OpenManage Storage Solutions (OMSS) tool provided by Dell Products L.P enhanced to perform generalized adaptive endpoint prediction for storage devices, such as storage device 118.

Bus/es 103 provides a mechanism for the various components of system 104 to communicate and couple with one another. As shown, host processing device/s 106 may be coupled in an embodiment to bus/es 103 via hostbridge 180 that may be a separate component (e.g., such as a Northbridge chip) or its functions may be integrated within host processing device 106 as illustrated by dashed line 179 in FIG. 1. In either case, hostbridge 180 is directly coupled to system memory 121 as shown, while hostbridge 180 may be coupled through a separate Southbridge chip (or platform controller hub “PCH” chip) 181 to facilitate input/output functions for the processing device/s 106 with various internal system components of information handling system 104 through bus/es 103 such as PCI, PCIe, SPI, USB, low pin count (LPC), etc. Examples of such system components that may be accessed through Southbridge/PCH 181 include, but are not limited to, NVRAM, BIOS SPI Flash, NVDIMMS, DIMMS, PCIe Devices, etc.

In one embodiment, host processing device/s 106 may be an in-band processing device configured to run a host operating system (OS) 105. Besides memory 121 (e.g., random access memory “RAM”), processor 106 may include cache memory for storage of frequently accessed data. Information handling system 104 may also include a network access card (NIC) 131 that is communicatively coupled to network 133 (e.g., Internet or corporate intranet) as shown to allow various components of system 104 to communicate with external and/or remote device/s 135 across network 133. Other external devices, such as an external universal serial bus (USB) device 170 may be coupled to processing device/s 106 via Southbridge/PCH 181. In this embodiment, information handling system 104 also includes power supply unit (PSU) 192 that is coupled to receive power from AC mains 190 and to perform appropriate power conversion and voltage regulation to produce regulated internal power 194 for use by other power-consuming components of system 104. System 104 may also include a baseboard management controller (BMC) (not shown). As shown, in the embodiment of FIG. 1 the host system 104 may provide access to a plurality of remote users 128-1 through 128-N, although access may be provided to a single user 128 in other embodiments. In this regard, remote users many manage, administer, use, and/or access various resources of host system 104 (e.g., either native or virtual) from a remote location, e.g., via network 133 and/or other suitable communication medium or media.

It will be understood that the embodiment of FIG. 1 is exemplary only, and that an information handling system may be provided with one or more processing devices that may perform the functions of host processing device/s 106, etc. Examples of such processing devices include, but are not limited to, central processing units (CPUs), embedded controllers, microcontrollers, application specific integrated circuits (ASICs), field programmable gate arrays (FPGAs), etc. It will also be understood that the particular configuration of FIG. 1 is exemplary only, and that other information handling system architectures may be employed in the practice of the disclosed systems and methods.

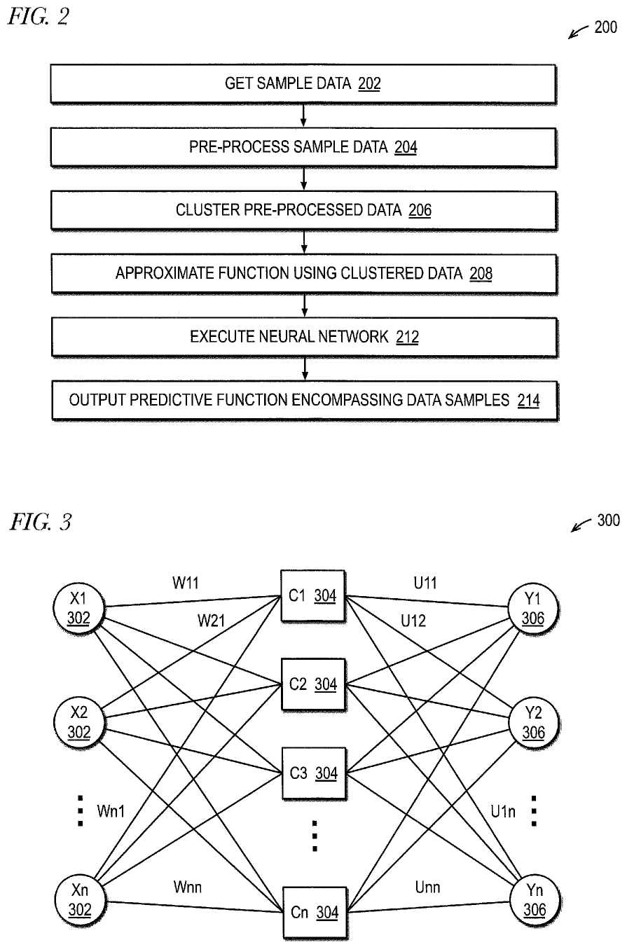

FIG. 2 is a flow diagram illustrating operation of the information handling system 104 to perform generalized adaptive storage endpoint prediction according to one embodiment of the disclosed systems and methods. Flow begins at block 202.

At block 202, the management application 199 collects samples of data related to the storage device 118. The management application 199 may query the controller 140 on the storage device 118 to collect the data samples and may do so via the BIOS 101 and/or the operating system 105. In one embodiment, the data samples are collected at different times on an ongoing basis (e.g., once or multiple times daily) during operation of the information handling system 104 and the storage device 118 and accumulated and stored for use by the remaining steps (e.g., blocks 204 through 214) as an accumulated data sample set. The data sample set may be stored by the information handling system 104, e.g., on the storage device 118 itself and/or in the system memory 121. Therefore, the size of the data sample set may be larger each time the remaining steps are performed.

Examples of the types of data samples collected may include, but are not limited to, a remaining rated write endurance (RRWE) indication, an available spare indication, a remaining drive space indication, and a remaining storage capacity indication. The RRWE may be an indication of the program erase (PE) cycles performed on an SSD. In one embodiment, a data sample received from the controller 140 of the storage device 118 specifies the number of physical erase cycles completed on the SSD as a percentage of the maximum physical erase cycles the drive is designed to endure, which may be provided by a storage device 118 that supports the S.M.A.R.T. (Self-Monitoring, Analysis and Reporting Technology) interface, for example, the value having identifier 0xE8 and attribute name “Endurance Remaining.” For another example, certain models of Intel® SSD may provide a S.M.A.R.T. attribute identifier 0x05 and name “Percentage Used Estimate” that indicates the estimated percentage of the SSD's endurance that has been consumed. Such values may be subtracted from 100% to compute an RRWE data sample which indicates the remaining PE cycles available on the SSD as a percentage of specified PE guaranteed by the SSD manufacturer. Once the RRWE has reached 0%, the drive has become read-only (no longer writable) and may be characterized as having reached an endpoint in its lifetime. The available spare indication is an indication of the number of remaining spare blocks as a percentage of the total number of spare blocks available on the storage device 118, which may be provided by a storage device 118 that supports the S.M.A.R.T. interface, for example, the value having identifier 0xFB and attribute name “Minimum Spares Remaining.” For another example, certain models of Intel® SSD may provide a S.M.A.R.T. attribute identifier 0xE8 and name “Available Reserved Space” that indicates a normalized percentage of the number of reserve blocks remaining. Once the remaining spare blocks has reached 0%, the drive may be characterized as having reached an endpoint in its lifetime. The remaining drive space indication is an indication of the number of free blocks as a percentage of the total blocks of the storage device 118. Once the remaining drive space has reached 0%, the drive may be characterized as having reached an endpoint in its lifetime. The remaining storage capacity indication is an indication of an aggregation of all storage devices 118 (e.g., SSDs) connected to the information handling system 104. The collected data samples reflect hardware status of the storage device 118 and historical usage of the storage device 118 by the information handling system 104 during its operation and may therefore be used to make predictions about future usage and endpoints of the storage device 118 (e.g., write endurance consumed, spares exhausted, full condition), as described in more detail below. Flow proceeds from block 202 to block 204.

At block 204, the information handling system 104 pre-processes the data samples collected at block 202. The different types of data that have been collected from the system 104 are pre-processed to aid in the extraction of the patterns. In one embodiment, the preprocessor finds the minimum and maximum span of all data samples. Depending upon the type of data, the span may have a unique signature. In one embodiment, deltas, or changes, or distances, are computed between data samples that are adjacent in time. For example, a data sample value obtained one day is subtracted from the data sample value obtained the previous day to determine a delta/change/distance in the value of the particular data sample type between the two days. The delta/change/distance may be used as input to the clustering and function approximation modules, which are described below. The rates of change of the various data samples may be used by the information handling system 104 to adaptively predict storage endpoints, as described in more detail below. Flow proceeds to block 206.

At block 206, the information handling system 104 clusters the data samples in order to help identify patterns in the data samples. The clustering module classifies data samples into two groups: core samples and border samples. The data samples having a similar pattern are grouped together as a cluster using the Euclidean distance metric, \sqrt{(xᵢ−xⱼ)²+(yᵢ−yⱼ)²}. The core samples have similar type of samples in their neighborhood. In one embodiment, the y values in the Euclidean distance metric correspond to time, e.g., day number, and the x values correspond to the storage-related data sample type, e.g., RRWE, available spare/remaining drive space, remaining storage capacity. The border samples satisfy the metric only for one half of the neighborhood, and samples that do not satisfy the metric fall under a different cluster. A mean and variance is determined for each cluster. In one embodiment, a density-based spatial clustering of applications with noise (DBSCAN) algorithm is employed to cluster the samples, although other clustering algorithms may be employed. The DBSCAN clustering algorithm may be performed using one of various available software packages, such as the Apache Commons Mathematics Library, DBSCAN capabilities built into the R programming language, and the Waikato Environment for Knowledge Analysis (WEKA) suite of machine learning software developed at the University of Waikato, New Zealand. In one embodiment, the number of clusters need not be predetermined, but instead may be determined dynamically based upon the pattern present in the data samples. The clustering module returns the cluster label of each data sample. The span determined at block 204 may be employed to control which and/or how values are included in the clusters, such as the minimum number of samples in a cluster. Flow proceeds to block 208.

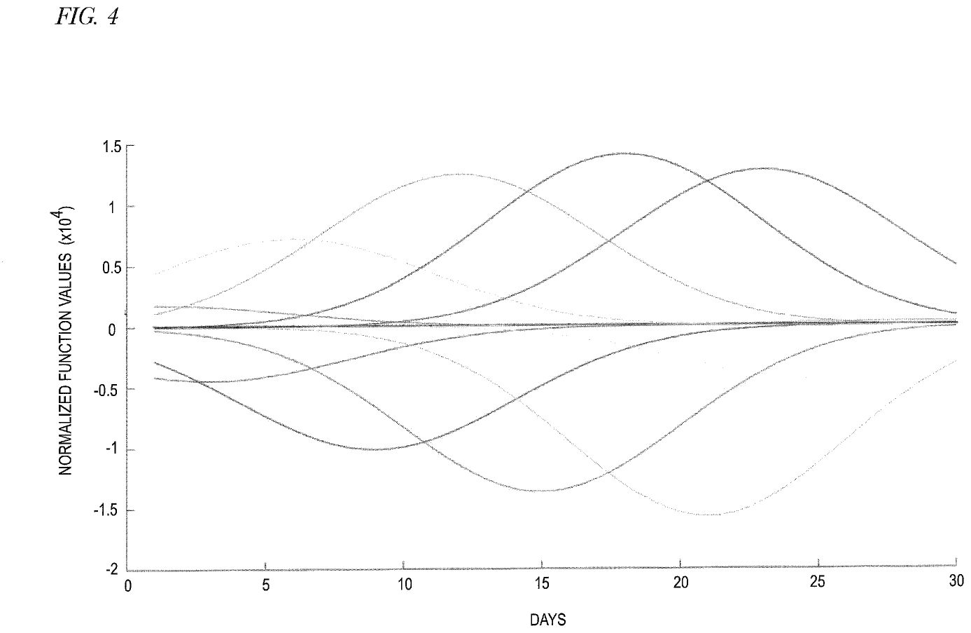

At block 208, the information handling system 104 approximates a function using the clustered data. The function approximator module receives the data samples and their corresponding cluster labels as input and forwards them to the neural network 300 (e.g., FIG. 3) for function approximation, i.e., the neural network 300 is a part of the function approximator. The neural network 300 returns a polynomial function that fits the pattern present in the data samples. The function that is generated is a combination of multiple Gaussian functions. Each Gaussian function is associated with a cluster determined during the clustering step performed at block 206. An example of such Gaussian functions may be observed in FIG. 4. The output of the neural network 300 is the coefficients of the combination of the Gaussian functions. The mean and variance of the Gaussian functions is calculated during the clustering operation performed at block 206. FIG. 4, discussed in more detail below, illustrates an example of normalized function values approximated from the data samples. Flow proceeds to block 212.

At block 212, the neural network 300 executes. The neural network 300 module receives the data samples, their corresponding cluster labels, and the cluster centers as input. In response, the neural network 300 approximates a function that may be used to predict an endpoint for a storage device, such as storage device 118, according to various use cases described, for example. In one embodiment, the neural network 300 is a single layer feed-forward neural network with constant bias and Gaussian activation function, as described in more detail below with respect to FIG. 3. Flow proceeds to block 214.

At block 214, the information handling system 104 outputs a predictive function encompassing the data samples. Flow ends at block 214.

FIG. 3 is a block diagram illustrating a neural network 300 that may be executed by the information handling system 104 according to one embodiment of the disclosed systems and methods. The embodiment of FIG. 3 is a class of feedforward artificial neural network. However, other embodiments are contemplated in which other classes of artificial neural networks may be employed to perform the function approximation of the generalized adaptive storage endpoint prediction. The network 300 of FIG. 3 is a single layer feed-forward neural network having an input layer, a hidden layer and an output layer. The input layer comprises a plurality of input nodes X 302, denoted X1 302, X2 302 through Xn 302, which provide the data samples. In one embodiment, the input nodes X 302 correspond to different time values, e.g., different days. The hidden layer comprises a plurality of hidden nodes C 304, denoted C1 304, C2 304, C3 304 through Cn 304. The hidden nodes C 304 may be associated with cluster centers. The output layer comprises a plurality of output nodes Y 306, denoted Y1 306, Y2 306 through Yn 306. In one embodiment, the output nodes Y 306 are endpoint percentages, e.g., percent of remaining available writes, spares, or drive space. In the embodiment of FIG. 3, the network 300 is a fully connected neural network, i.e., each input node X 302 is connected to each hidden node C 304, and the output of each hidden node C 304 is connected to each output node Y 306. Each connection between two nodes has an associated weight value. The weight values connecting the input nodes X 302 to the hidden nodes C 304 are denoted Wxc, where x denotes the index of the input node X 302 and c denotes the index of the hidden node C 304. For example, the weight associated with the connection between input node X1 302 and hidden node C1 304 is denoted W11, the weight associated with the connection between input node X2 302 and hidden node C1 304 is denoted W21, and the weight associated with the connection between input node Xn 302 and hidden node Cn 304 is denoted Wnn, as shown. The weight values connecting hidden nodes C 304 to the output nodes Y 306 are denoted Ucy, where c denotes the index of the hidden node C 304 and x denotes the index of the output node Y 306. For example, the weight associated with the connection between hidden node C1 304 and output node Y1 306 is denoted U11, the weight associated with the connection between hidden node C1 304 and output node Y2 306 is denoted U12, and the weight associated with the connection between hidden node Cn 304 and output node Yn 306 is denoted Unn, as shown. In one embodiment, the weights are initialized with random values and are adjusted, or trained, based on the storage device usage data samples using backpropagation.

The module performing the neural network 300 receives the data samples, corresponding cluster labels and the cluster centers as input. The inputs are passed through to hidden layer nodes C 304 each of which multiplies each input by its corresponding weight and then generates a sum of the products. The output of a single neuron, or hidden node C 304, is specified by the following equations (1), (2) and (3) in which w indicates a weight, w^{T} indicates a matrix of the weights of the neural network 300, b indicates a constant bias, xᵢ indicates the j^{th} data sample, cᵢ indicates the cluster center of the i^{th} cluster, σ₁ is a variance of the i-th cluster, and the activation function is Gaussian. The mean and variance of the Gaussian activation function is calculated as the mean and variance of the corresponding cluster.

$$\begin{matrix}Radial function = ( {x}_{j} - {c}_{i} ) & ( 1 ) \\ Equation of Hyper \text{-} plane = ( {w}^{T} x + b ) & ( 2 ) \\ Output of a single perception in the artwork = \frac{1}{{σ}_{i} \sqrt{2 π}} {e}^{- \{ \frac{{( {w}^{T} ( {x}_{j} - {C}_{i} ) + b )}^{2}}{2 {σ}^{2}} \}} & ( 3 )\end{matrix}$$

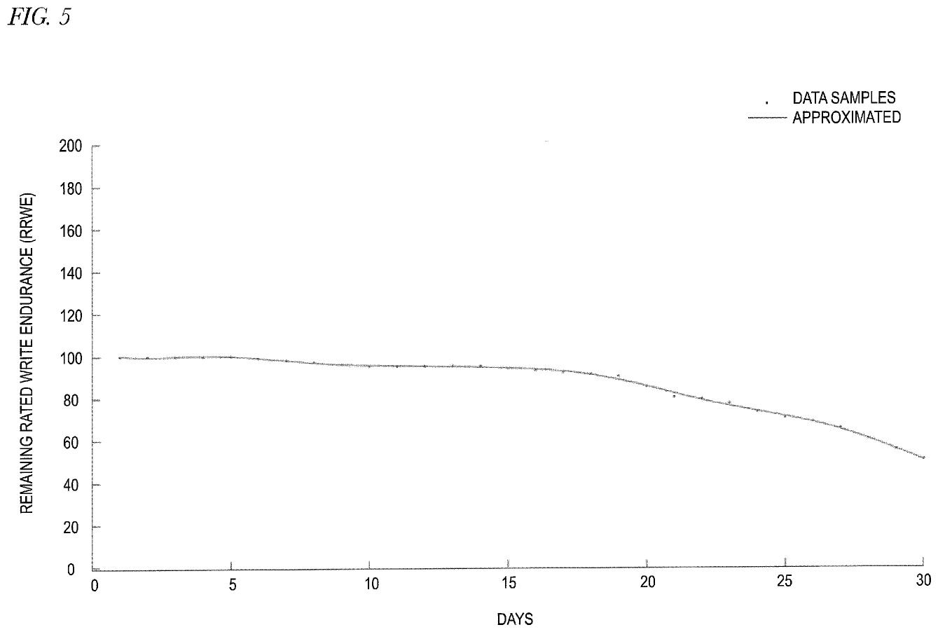

The output of a single perceptron, equation (3), in the neural network 300 is the Gaussian function which is generated for a single cluster. The Gaussian functions generated from the different clusters are combined to produce the final approximated function, an example of which is shown in FIG. 5. The equation of Hyper-plane, equation (2), is a general mathematical representation of a neuron of the neural network 300. The neural network 300 module may be constructed using any of various artificial neural network tools or packages, such as the TensorFlow open-source software library developed by Google LLC of Mountain View, Calif. or the Theano open-source Python-based numerical computation library developed at the University of Montreal among others.

FIG. 4 is a graph illustrating aspects of operation of the information handling system 104 of FIG. 1 according to one embodiment of the disclosed systems and methods. More specifically, FIG. 4 illustrates aspects of operation of the neural network 300 to approximate a non-linear function, e.g., from low dimensional low sample size data, to predict endpoints usable for system/storage management, such as end of life of an SSD, e.g., due to the SSD having become no longer writeable (also referred to as have entered a read-only mode), no more available spares, drive full, etc. The graph illustrates time, e.g., in days as shown, as the independent variable on the horizontal axis and normalized function values as the dependent variable on the vertical axis. FIG. 4 shows 30 days of time. FIG. 4 shows 30 days of time, although it should be understood that the amount of time spans out to the endpoint in time predicted based on the sampled data. The normalized function values are unitless and are in a range of between about −1.5×10⁴ to +1.5×10⁴ in the example of FIG. 4. FIG. 4 shows contributing kernel functions. As described above, at block 206 of FIG. 2, the clustering step determines a mean and variance for each cluster. The different Gaussian functions created from different clusters may be multiplied by different constants. To generalize the Gaussian functions, all the constants of the Gaussian functions are normalized. FIG. 4 illustrates an example of different Gaussian functions from different clusters, which are passed through the neural network 300 to generate combinational coefficients for each Gaussian, and when added together, give rise to a function that may be used to predict a storage endpoint, an example of which is shown in FIG. 5. The normalized function values are used by the management application 199 to approximate the non-linear function to predict a storage device endpoint, such as the non-linear function shown in the graph of FIG. 5.

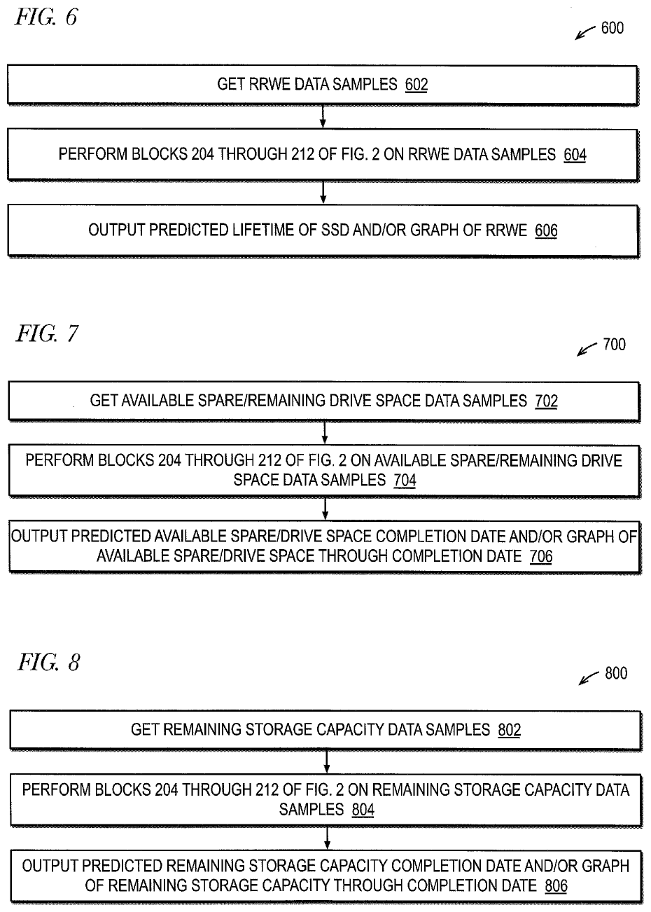

FIG. 5 is a graph illustrating aspects of the operation of the information handling system 104 of FIG. 1 according to one embodiment of the disclosed systems and methods. More specifically, FIG. 5 illustrates aspects of the information handling system 104 to provide endpoint information related to a storage device, e.g., storage device 118 of FIG. 1, to aid a user in making storage management decisions, e.g., storage acquisition and/or provisioning decisions, based on the predicted endpoint information. The graph illustrates time, e.g., in days as shown, as the independent variable on the horizontal axis and RRWE values as the dependent variable on the vertical axis. FIG. 5 shows 30 days of time, although it should be understood that the amount of time spans out to the endpoint in time predicted based on the sampled data. For example, if RRWE percentage reaches zero percent (i.e., end of life) at 1,250 days, then the RRWE values are predicted and displayed for 1,250 days. Advantageously, a user may observe the graph to determine when the storage device 118 no longer is capable of being written (e.g., SSD has reached its write endurance rating, e.g., performed the maximum PE cycles for all of its blocks) as indicated by a 0% RRWE, and make storage device acquisitions well in advance of the endpoint date. As may be seen in FIG. 5, the input data points may also be graphed for the days in which the storage device 118 has been operational. For example, if data samples have been gathered for 30 days of operation of the storage device 118, these input data points may be shown on the graph in addition to the predicted values for the remaining days until the endpoint. Advantageously, embodiments described may make endpoint predictions using a relatively small amount of data samples (e.g., 30 days) even though the endpoint may be one or two orders of magnitude longer than the time over which the storage device 118 has been used/operated and data samples have been gathered. Further advantageously, the embodiments described are adaptive in that they may predict different non-linear functions as time goes on using the increased amount of data samples available to make more accurate endpoint predictions than were made with less data points. In one embodiment, at least one week worth of data samples are gathered in order to make an endpoint prediction. Although FIG. 5 illustrates a use case that predicts storage device lifetime based on SSD write endurance, it should be understood that FIG. 5 is given as an illustrative example, and other use cases may similarly display a graph that predicts other storage device endpoints using data samples of other types, such as described with respect to the use cases of FIGS. 7 and 8 described below in more detail. Advantageously, embodiments of the information handling system 104, including the management application 199, are generalized such that they may be applied to any type of data samples of interest that may be gathered for the storage device 118 and for which an endpoint may be predicted.

FIG. 6 is a flow diagram illustrating operation of the information handling system 104 for a first use case according to one embodiment of the disclosed systems and methods. Flow begins at block 602.

At block 602, the management application 199 collects RRWE data samples from the storage device 118. As described above, the management application 199 may query the controller 140 on the storage device 118 to collect the RRWE data samples and may do so once or multiple times daily and accumulate and store an accumulated data sample set on the storage device 118 itself and/or in the system memory 121. Flow proceeds to block 604.

At block 604, the information handling system 104 performs blocks 204 through 212 of FIG. 2 on the RRWE data samples collected at block 602. That is, the information handling system 104 pre-processes the RRWE samples, clusters them (e.g., using DBSCAN), and uses a neural network (e.g., neural network 300 of FIG. 3) to estimate a non-linear function that may be used to predict when the storage device 118 will reach its end of life, e.g., the RRWE will reach 0% or some other threshold value, e.g., specified by the user. Flow proceeds to block 606.

At block 606, the information handling system 104 outputs a predicted lifetime (e.g., number of days remaining) of the storage device 118 based on the predictive function generated at block 604. Alternatively, the information handling system 104 outputs a graph of RRWE of the storage device 118 based on the predictive function generated at block 604, e.g., a graph similar to the graph of FIG. 5 (although extending out to the RRWE endpoint). Flow ends at block 606.

FIG. 7 is a flow diagram illustrating operation of the information handling system 104 for a second use case according to one embodiment of the disclosed systems and methods. Flow begins at block 702.

At block 702, the management application 199 collects available spare or remaining drive space data samples from the storage device 118. As described above, the management application 199 may query the controller 140 on the storage device 118 to collect the data samples and may do so once or multiple times daily and accumulate and store an accumulated data sample set on the storage device 118 itself and/or in the system memory 121. Flow proceeds to block 704.

At block 704, the information handling system 104 performs blocks 204 through 212 of FIG. 2 on the data samples collected at block 702. That is, the information handling system 104 pre-processes the available spare or remaining drive space samples, clusters them (e.g., using DBSCAN), and uses a neural network (e.g., neural network 300 of FIG. 3) to estimate a non-linear function that may be used to predict when the storage device 118 will reach its end of life, e.g., the available spares or remaining drive space will reach 0% or some other threshold value, e.g., specified by the user. Flow proceeds to block 706.

At block 706, the information handling system 104 outputs a predicted lifetime (e.g., number of days remaining) of the storage device 118 based on the predictive function generated at block 704. Alternatively, the information handling system 104 outputs a graph of available spares or remaining drive space of the storage device 118 based on the predictive function generated at block 704, e.g., a graph similar to the graph of FIG. 5 (although displaying available spare or remaining drive space and extending out to the available spare or remaining drive space endpoint). Flow ends at block 706.

FIG. 8 is a flow diagram illustrating operation of the information handling system 104 for a third use case according to one embodiment of the disclosed systems and methods. Flow begins at block 802.

At block 802, the management application 199 collects remaining storage capacity data samples from all the storage devices (e.g., of the type of storage device 118, e.g., SSD) in the information handling system 104. Flow proceeds to block 804.

At block 804, the information handling system 104 performs blocks 204 through 212 of FIG. 2 on the remaining storage capacity data samples collected at block 802. That is, the information handling system 104 pre-processes the remaining storage capacity samples, clusters them (e.g., using DBSCAN), and uses a neural network (e.g., neural network 300 of FIG. 3) to estimate a non-linear function that may be used to predict when the remaining storage capacity of the information handling system 104 will reach its end of life, e.g., the remaining storage capacity will reach 0% or some other threshold value, e.g., specified by the user. Flow proceeds to block 806.

At block 806, the information handling system 104 outputs a predicted lifetime (e.g., number of days remaining) of the storage device 118 based on the predictive function generated at block 804. Alternatively, the information handling system 104 outputs a graph of remaining storage capacity of the information handling system 104 storage devices based on the predictive function generated at block 804, e.g., a graph similar to the graph of FIG. 5 (although displaying remaining storage capacity and extending out to the remaining storage capacity endpoint). Flow ends at block 806.

Embodiments described may provide useful endpoint predictions for storage devices, e.g., SSDs, to improve the operation of the information handling system 104. Advantageously, the endpoint predictions may enable a user (e.g., system/storage administrator) to maintain storage hardware in such a manner as to avoid data loss caused by unavailability of storage. The embodiments advantageously analyze unstructured live storage device usage data (e.g., RRWE, available spares, drive space, etc.) and predict the time line, or endpoint, of the storage. Advantageously, the embodiments may predict non-linear functions that provide the endpoint predictions from low dimensional low sample size data. In one embodiment, the information handling system 104 may automate certain decisions regarding storage management using the endpoint predictions, such as automatic procurement of additional storage devices and/or placing into operation reserved storage devices. In one embodiment, the information handling system 104 may process and predict multi-dimensional data. For example, the information handling system 104 may predict a storage device endpoint based on usage data samples of RRWE, available spare percentage and available drive space percentage, and may graph all three of the respective predicted non-linear functions on a single graph for an administrator to observe and make storage management decisions based thereon. For example, if the RRWE will reach 0% on day 1,300, the available spare percentage will reach 0% on day 1,220, and the available drive space will reach 0% on day 1,255, then the administrator may make management choices around the 1,220 day mark rather than the day 1,255 and the 1,300 day mark. Similarly, the multi-dimensional prediction data may be fed to an automated management application 199 that similarly makes automated decisions based on the multi-dimensional data.

It will be understood that the steps of FIGS. 2 and 6 through 8 are exemplary only, and that any combination of fewer, additional and/or alternative steps may be employed that are suitable to perform generalized adaptive storage endpoint prediction.

It will be understood that one or more of the tasks, functions, or methodologies described herein (e.g., including those described herein for components 106, 109, 131, 180, 181, 133, etc.) may be implemented by circuitry and/or by a computer program of instructions (e.g., computer readable code such as firmware code or software code) embodied in a non-transitory tangible computer readable medium (e.g., optical disk, magnetic disk, non-volatile memory device, etc.), in which the computer program comprising instructions is configured when executed on a processing device in the form of a programmable integrated circuit (e.g., processor such as CPU, controller, microcontroller, microprocessor, ASIC, etc. or programmable logic device “PLD” such as FPGA, complex programmable logic device “CPLD”, etc.) to perform one or more steps of the methodologies disclosed herein. In one embodiment, a group of such processing devices may be selected from the group consisting of CPU, controller, microcontroller, microprocessor, FPGA, CPLD and ASIC. The computer program of instructions may include an ordered listing of executable instructions for implementing logical functions in an information handling system or component thereof. The executable instructions may include a plurality of code segments operable to instruct components of an information handling system to perform the methodologies disclosed herein.

It will also be understood that one or more steps of the present methodologies may be employed in one or more code segments of the computer program. For example, a code segment executed by the information handling system may include one or more steps of the disclosed methodologies. It will be understood that a processing device may be configured to execute or otherwise be programmed with software, firmware, logic, and/or other program instructions stored in one or more non-transitory tangible computer-readable mediums (e.g., data storage devices, flash memories, random update memories, read only memories, programmable memory devices, reprogrammable storage devices, hard drives, floppy disks, DVDs, CD-ROMs, and/or any other tangible data storage mediums) to perform the operations, tasks, functions, or actions described herein for the disclosed embodiments.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touch screen and/or a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed methods and systems may be utilized in various combinations and/or independently. Thus, the invention is not limited to only those combinations shown herein, but rather may include other combinations.

What is claimed is:

1. An information handling system, comprising:
a programmable integrated circuit;
a storage device; and
a system/storage management application executing on the programmable integrated circuit that:
gathers data samples pertaining to operation of the storage device;
clusters the data samples into a plurality of clusters; and
approximates a polynomial function usable to predict an endpoint of the storage device by using an artificial neural network that receives the data samples and clusters and in response generates the approximated polynomial function.

2. The information handling system of claim 1,
where the storage device comprises a solid state drive (SSD).

3. The information handling system of claim 1,
where each of the data samples comprises an information value and a time value;
where the information values are of a selected information type from a list of information types comprising:
remaining rated write endurance of the storage device;
available spare blocks of the storage device;
remaining drive space of the storage device; and
remaining storage capacity of all storage devices in the information handling system; and
where the predicted endpoint is a time at which the approximated polynomial function predicts an information value of the selected information type will drop below a predetermined value.

4. The information handling system of claim 1,
where to cluster the data samples into the plurality of clusters the application employs a DBSCAN (density based spatial clustering of application with noise) algorithm.

5. The information handling system of claim 1,
where the approximate polynomial function is a combination of a plurality of Gaussian functions corresponding to the plurality of clusters.

6. The information handling system of claim 5,
where to cluster the data samples into the plurality of clusters the application calculates a mean and variance associated with each cluster of the plurality of clusters that is a mean and variance of the corresponding Gaussian function of the plurality of Gaussian functions.

7. The information handling system of claim 1,
where the artificial neural network is a feed forward artificial neural network having at least one hidden layer, constant bias, and Gaussian activation function.

8. The information handling system of claim 7,
where for each neuron of a plurality of neurons of the at least one hidden layer, the neuron has a radial function (xᵢ−cⱼ) and a hyper-plane equation (w^{T}x+b), where xⱼ is a j-th data sample of the gathered data samples, cᵢ is a center of an i-th cluster of the plurality of clusters, w^{T} is a weight matrix of the neuron, and b is bias of the neuron.

9. The information handling system of claim 8,
where an output of a single perceptron of the artificial neural network has equation
$$\frac{1}{{σ}_{i} \sqrt{2 π}} {e}^{- \{ \frac{{( {w}^{T} ( {x}_{j} - {C}_{i} ) + b )}^{2}}{2 {σ}^{2}} \}} ,$$
where σ₁ is a variance of the i-th cluster.

10. A method for use in an information handling system having a storage device, the method comprising:
gathering data samples pertaining to operation of the storage device;
clustering the data samples into a plurality of clusters; and
approximating a polynomial function usable to predict an endpoint of the storage device by using an artificial neural network that receives the data samples and clusters and in response generates the approximated polynomial function.

11. The method of claim 10,
where the storage device comprises a solid state drive (SSD).

12. The method of claim 10,
where each of the data samples comprises an information value and a time value;
where the information values are of a selected information type from a list of information types comprising:
remaining rated write endurance of the storage device;
available spare blocks of the storage device;
remaining drive space of the storage device; and
remaining storage capacity of all storage devices in the information handling system; and
where the predicted endpoint is a time at which the approximated polynomial function predicts an information value of the selected information type will drop below a predetermined value.

13. The method of claim 10,
where said clustering the data samples into the plurality of clusters comprises employing a DBSCAN (density based spatial clustering of application with noise) algorithm.

14. The method of claim 10,
where the approximate polynomial function is a combination of a plurality of Gaussian functions corresponding to the plurality of clusters.

15. The method of claim 14,
where said clustering the data samples into the plurality of clusters comprises calculating a mean and variance associated with each cluster of the plurality of clusters that is a mean and variance of the corresponding Gaussian function of the plurality of Gaussian functions.

16. The method of claim 10,
where the artificial neural network is a feed forward artificial neural network having at least one hidden layer, constant bias, and Gaussian activation function.

17. The method of claim 16,
where for each neuron of a plurality of neurons of the at least one hidden layer, the neuron has a radial function (xⱼ−cᵢ) and a hyper-plane equation (w^{T}x+b), where xⱼ is a j-th data sample of the gathered data samples, cᵢ is a center of an i-th cluster of the plurality of clusters, w^{T} is a weight matrix of the neuron, and b is bias of the neuron.

18. The method of claim 17,
where an output of a single perceptron of the artificial neural network has equation
$$\frac{1}{{σ}_{i} \sqrt{2 π}} {e}^{- \{ \frac{{( {w}^{T} ( {x}_{j} - {C}_{i} ) + b )}^{2}}{2 {σ}^{2}} \}} ,$$
where σ₁ is a variance of the i-th cluster.

19. A non-transitory computer-readable medium having instructions stored thereon that are capable of causing or configuring an information handling system having at least one programmable integrated circuit and a storage device to perform operations comprising:
gathering data samples pertaining to operation of the storage device;
clustering the data samples into a plurality of clusters; and
approximating a polynomial function usable to predict an endpoint of the storage device by using an artificial neural network that receives the data samples and clusters and in response generates the approximated polynomial function.

20. The non-transitory computer-readable medium of claim 19, having instructions stored thereon that are capable of causing or configuring an information handling system having at least one programmable integrated circuit and a storage device to perform operations further comprising:
where said clustering the data samples into the plurality of clusters comprises employing a DBSCAN (density based spatial clustering of application with noise) algorithm;
where the approximate polynomial function is a combination of a plurality of Gaussian functions corresponding to the plurality of clusters; and
where said clustering the data samples into the plurality of clusters comprises calculating a mean and variance associated with each cluster of the plurality of clusters that is a mean and variance of the corresponding Gaussian function of the plurality of Gaussian functions.
